(19) United States
(12) Patent Application Publication
(10) Pub. No.: US 2010/0219035 A1
(43) Pub. Date: Sep. 2, 2010

(54) TORQUE TRANSMISSION DEVICE

(75) Inventor: Wolfram Hasewend, Graz (AT)

Correspondence Address: HARNESS, DICKEY & PIERCE, P.L.C., P.O. BOX 828, BLOOMFIELD HILLS, MI, 48303, US

(73) Assignee: MAGNA POWERTRAIN AG & CO KG, Lannach (AT)

(21) Appl. No.: 12/602,916

(22) PCT Filed: Jun. 2, 2008
(86) PCT No.: PCT/EP08/04383

§ 371 Date: May 10, 2010

(30) Foreign Application Priority Data
Jun. 5, 2007 (DE) 10 2007 026 141.3

(51) Int. Cl. F16D 31/00

(52) U.S. Cl. 192/58.2

(57) ABSTRACT

The invention relates to a torque transmission device, especially for the drive train of a motor vehicle, said device comprising a pump comprising a first pump part, a second pump part, a suction chamber and a pressure chamber, the first pump part and the second pump part being mutually rotatable. A rotary movement of the first pump part in relation to the second pump part allows a hydraulic fluid to be transported from the suction chamber into the pressure chamber of the pump, torque transmitted between the first pump part and the second pump part depending on the pump pressure generated by the pump. At least one pressure control device is associated with the pump, said device constricting a fluid stream transported by the pump in a variable manner in order to vary the rotational speeds of the first pump part and the second pump part in relation to each other.

### CROSS REFERENCE TO RELATED APPLICATIONS

This application is a National Stage of International Application No. PCT/EP2008/004383 filed Jun. 2, 2008 which claims the benefit of German Patent Application No. 10 2007 026 141.3 filed Jun. 5, 2007. The disclosures of the above applications are incorporated herein by reference in their entirety.

### FIELD

The invention relates to a torque transfer device for a powertrain of a motor vehicle, in particular in the form of a hydrostatic clutch, which enables speed of rotation balance between two shafts.

### BACKGROUND

The statements in this section merely provide background information related to the present disclosure and may not constitute prior art.

Powertrains of motor vehicles have a number of torque transfer devices by which the driving torque of an engine of the vehicle are transferred to the driven wheels. The torque transfer can also be controlled by the torque transfer devices on changes in driving conditions of the vehicle. Powertrains for the starting up of the vehicle, for example, thus have special torque transfer devices between the engine and a main transmission of the vehicle.

The special aspect of a starting up situation lies in the fact that an output shaft of the engine rotates at a given speed of rotation, while an input shaft of the main transmission is at rest. On a sudden decoupling, the input shaft of the main transmission—and thus also its components—would have to be accelerated abruptly, which results in a number of problems in the powertrain and in the engine of the vehicle. The situation is similar on a change between different gear ratios of the main transmission. To be able to cope with this situation, powertrains usually have special start-up elements by which the engine and the main transmission can be coupled in a controlled manner. With manual or automated manual transmissions, use is usually made of a friction clutch as the start-up element, whereas with automatic transmissions hydrodynamic torque converters are used.

However, the known start-up elements have a number of disadvantages. As initially described, particularly large speed of rotation differences are present between the engine and the main transmission in a starting up situation. On the use of a friction clutch as the start-up element, they result in a substantial heat generation in the interior of the clutch so that the friction clutch has to be designed for a correspondingly large heat absorption or a powerful pump is additionally required for the cooling of the friction clutch. Hydrodynamic torque converters, in contrast, have an unsatisfactory efficiency due to their construction so that a torque converter bridging clutch is brought into engagement after the end of the starting up procedure to couple the output shaft of the engine and the input shaft of the main transmission directly rotationally fixedly to one another while avoiding the hydrodynamic torque converter. In addition, the hydrodynamic torque converter has fixed characteristic properties so that an active control of the torque transfer characteristic—and thus of the starting up procedure—is not possible.

### SUMMARY

It is an object of the invention to provide a robust and compact torque transfer device whose torque transfer behavior is simple to control. A further object of the present invention is to provide a powertrain of a vehicle which enables an improved torque transfer between the engine and the main transmission.

The torque transfer device in accordance with the invention includes a pump which has a first pump part (e.g. a pump housing), a second pump part (e.g. a pump rotor), a suction space and a pressure space, with the first pump part and the second pump part being rotatable relative to one another, with a hydraulic fluid being conveyable from the suction space into the pressure space of the pump by a rotary movement of the first pump part relative to the second pump part. A torque can be transferred between the first pump part and the second pump part via the hydraulic fluid, with this torque being proportional to the pump pressure generated by the pump. At least one pressure control device is associated with the pump by means of which a fluid flow conveyed by the pump is variably restrictable to vary the rotary speed of the first pump part and of the second pump part relative to one another.

The torque transfer device thus includes a pump, with the torque transfer taking place hydrostatically from the first pump part to the second pump part—or vice versa. The first pump part in this respect forms an outer rotor, for example, which does not have to surround the second pump part at all sides. If a rotational speed difference is present between the first pump part and the second pump part of the pump, a hydraulic fluid is conveyed from the suction space of the pump into the pressure space of the pump. The conveyed volume depends on a geometry of the pump and on the rotational speed difference between the first pump part and the second pump part. The counter-pressure prevailing in the pressure space is also decisive since the pump cannot convey fluid against a counter-pressure of any desired high level. The counter-pressure acting against the pump power can therefore be controlled via an intervention in the conveyed volume flow of the hydraulic fluid, which in turn influences the hydrostatic coupling of the second pump part to the first pump part—and thus the rotational speed difference and the torque transfer between the two named components. Such an intervention can be realized in a simple manner by a restriction. In other words, the degree of the mechanical coupling between the first pump part and the second pump part of the pump is controlled by a restriction of the fluid flow conveyed by the pump.

The control of the torque device in accordance with the invention is based on a hydraulic control which is simple to realize. Complex and wear-prone friction clutches and their actuator systems—such as manual or automated manual transmissions—are therefore dispensed with. The necessity of providing a separate hydraulic pump for the cooling of the torque transfer device is therefore likewise dispensed with since the heat output arising in the torque transfer device on a starting up procedure is led off by the hydraulic fluid itself. Ultimately, the fluid effecting the degree of mechanical coupling thus simultaneously acts as a coolant. The pump thus ultimately satisfies a threefold function, namely a conveying of a hydraulic fluid, a hydrostatic coupling for the purpose of the torque transfer and a coolant transport.

In contrast to a hydrodynamic torque converter used in automatic transmissions, the degree of the mechanical coupling is additionally actively controllable so that the torque transfer can be ideally matched to the respectively present conditions.

An embodiment of the torque transfer device of an advantageous design makes provision that both the first and the second pump parts are rotatably journalled.

In accordance with a further embodiment of the torque transfer device, the pump can be hydraulically blocked by means of the pressure control device to connect the second pump part substantially rotationally fixedly, i.e. without any significant slip, to the first pump part. As already discussed above, the pump cannot convey fluid against a counter-pressure of any desired high level. For example, the outflow of hydraulic fluid can be interrupted by a blocking of the pressure space, whereby the fluid pressure increases in the pressure space until the second pump part is no longer movable relative to the first pump part. The pump is then hydraulically blocked by a type of liquid column and the second pump part is connected to the fourth pump part in an almost rotationally fixed manner. Such a complete blocking ensures a practically loss-free torque transfer in this state so that, in contrast to a hydrodynamic torque converter, an additional bridging clutch can be dispensed with.

Provision can furthermore be made that the pump can be hydraulically short-circuited by means of the pressure control device to decouple the second pump part from the first pump part of the pump. A hydraulic short-circuit is to be understood as the idling of the pump, that is the pumps therefore does not generate any pump pressure, or only a minimal pump pressure, whereby any desired rotational speed difference can be adopted between the first pump part and the second pump part. In other words, the hydraulic fluid circulates substantially without restriction in the hydraulic circuit of the pump in this state.

To enable such a circulation, a short-circuit line of the pump connecting the pressure space and the suction space can extend along the first pump part—that is, for example, within the first pump part and/or at an outer side of the first pump part. Such a short-circuit line enables a substantially direct and thus almost power loss-free circulation of the hydraulic fluid from the pressure space into the suction space of the pump. The coupling between the first pump part and the second pump part is accordingly sufficiently small. The pressure control device can have a control valve by which the short-circuit line can be selectively opened or blocked, or this function is taken over by the restrictor valve still to be explained in the following.

The blocking and the short-circuiting of the pump thus form two extreme states of the torque transfer device. In the first case, a substantially complete transfer of a torque takes place, for example from a drive unit of the vehicle to a manual or automated manual transmission or to an automatic transmission, whereas in the second case, the drive unit and the main transmission are substantially completely decoupled. Intermediate states between these two extremes can be realized by a restriction of the fluid flow conveyed by the pump. For this purpose, the pressure control device can include at least one controllable restrictor valve by means of which the fluid flow conveyed by the pump can be restricted. The restrictor valve can, for example, be a laterally movable aperture diaphragm or an axially movable slider whose conical end forms a seated valve.

Provision can furthermore be made that the pressure space of the pump can be coupled directly, i.e. without any interposed booster pump and while bypassing a pump sump, to a suction line of the pump. A large fluid flow namely has to be conveyed in particular at large rotational speed differences. A feed pump for the provision of a minimal pressure of the fluid and for the balancing of leak losses can thus be dimensioned substantially smaller. The named direct coupling of the pressure space via the restrictor valve to the suction line in particular takes place within or along the same pump part. A high-pressure rotary leadthrough for the pump can thus be dispensed with.

In accordance with a compact further development of the torque transfer device in accordance with the invention, the restrictor valve is arranged at the first pump part (e.g. pump housing) or is integrated into the first pump part. With a first pump part rotatable about an axis of rotation, the restrictor valve arranged thereat or therein can be oriented such that its activation direction extends perpendicular to the axis of rotation of the rotatable first pump part, with the restrictor valve being designed such that a centrifugal force active on a rotation of the first pump part supports an opening of the restrictor valve. This represents an additional safety aspect.

Provision can furthermore be made that a cooling device is arranged along a connection path of the pressure space of the pump with a suction line of the pump—that is, for example, in any desired section of this path—for the cooling of the hydraulic fluid restricted by means of the restrictor valve, with the cooling device being arranged at a stationary housing of the torque transfer device. Such a cooling device enables the leading off in an efficient manner of the waste heat arising on operation of the torque transfer device, in particular in a starting up situation.

The restrictor valve can have an output opening, a first output opening and a second output opening, with the input opening being in communication with the pressure space of the pump. The first output opening is directly in communication with the suction space of the pump via a first connection line which extends along the first pump part, whereas the second output opening is in communication with the suction space of the pump via a second connection line which extends—at least partly—along a cooling device. Flow resistances and power losses accompanying them are reduced by the essentially direct connection of the first output opening to the suction space of the pump. The cooling device, in contrast, thus does not have to be arranged at the first pump part, but can rather, for example, be arranged at a stationary housing of the torque transfer device, i.e. in this case, the named second connection line extends—at least partly—along a stationary housing. An improved cooling capacity can hereby be achieved.

In accordance with a further development, the restrictor valve is designed such that the portions of the hydraulic fluid which respectively flow out through the output openings can be controlled by the restrictor valve, said hydraulic fluid flowing into the restrictor valve. In other words, the torque transfer device can be operated more efficiently by the controllable division of the hydraulic fluid flowing through the restrictor valve to the output openings. Provision can, for example, be made that in specific states a lot of hydraulic fluid is supplied to the first output opening to minimize power losses in the torque transfer device, whereas, conversely, in other states a lot of hydraulic fluid is supplied to the second output opening, for instance when the hydraulic fluid should be cooled more.

The pressure control device can be controllable such that a variably determinable portion of a torque can be transferred between the first pump part and the second pump part.

In a further embodiment of the torque transfer unit in accordance with the invention, at least one of the pump parts is surrounded peripherally by an annular space (in particular the suction space of the pump) which is substantially completely filled with the hydraulic fluid. An oil jacket peripherally surrounding the respective pump part is thus formed which effects an advantageous acoustic damping. Both the first pump part and the second pump part are preferably peripherally surrounded by the hydraulic fluid.

Alternatively or additionally, the suction space of the pump has an annular space which is bounded, for example, laterally and/or radially at the outside at least partly by an elastic ring wall which allows a volume change of the suction space in dependence on the fluid pressure in the interior of the suction space. An advantageous variant of the ring wall is designed as a ring hood which is formed at least partly by a metal envelope or by a metal bellows.

A pressure store is created by the elastic suction space boundary which contributes, among other things, to preventing the occurrence of cavitation in the hydraulic fluid, for example when sudden pressure changes occur in the suction space.

The first pump part of the pump is advantageously provided as an input of the torque transfer device and the second pump part is provided as an output of the torque transfer device. It is furthermore preferred if the pump is a radial piston pump.

In accordance with a further development of the torque transfer device in accordance with the invention, a control unit is provided by means of which the pressure control device can be controlled such that the restrictor valve for the hydraulic blocking of the pump is completely closed for a substantially complete transfer of a torque between the first pump part and the second pump part and such that the restrictor valve for the hydraulic short-circuiting of the pump is completely opened for a mutual decoupling of the first pump part and of the second pump part. The control unit can also be controllable such that a throughflow rate of the hydraulic fluid through the restrictor valve is reduced to increase the torque transferred between the first pump part and the second pump part and such that the throughflow rate of the hydraulic fluid through the restrictor valve is increased to reduce the torque transferred between the first pump part and the second pump part.

The first pump part is preferably connected to a flywheel via a rotary vibration damper. In this constellation, the first pump part likewise functionally forms a flywheel. A second flywheel conventionally provided can thus be dispensed with. The torque transfer device can thus include the rotary vibration damper and the flywheel in addition to the named pump.

In a further embodiment of the torque transfer device, the first pump part is connected to an output element of a drive unit of the motor vehicle and the second pump part is connected to an input shaft of a main transmission.

The invention moreover relates to a powertrain of a motor vehicle having a drive unit, a main transmission and a torque transfer device in accordance with any one of the above-described embodiments, with the torque transfer device being arranged between the drive unit and the main transmission.

Further areas of applicability will become apparent from the description provided herein. It should be understood that the description and specific examples are intended for purposes of illustration only and are not intended to limit the scope of the present invention.

### DRAWINGS

The invention will be described in the following purely by way of example with reference to advantageous embodiments and to the drawings. There are shown:

FIG. 1 is a schematic representation of an embodiment of the powertrain in accordance with the invention;

FIG. 2 illustrates a section through a radial piston pump;

FIGS. 3 to 6 are different aspects of a pressure control device of an embodiment of the torque transfer device in accordance with the invention;

FIG. 7 illustrates an embodiment of a restrictor valve;

FIG. 8 illustrates a section through a part of an embodiment of the torque transfer device in accordance with the invention;

FIG. 9 illustrates a section through the embodiment shown in

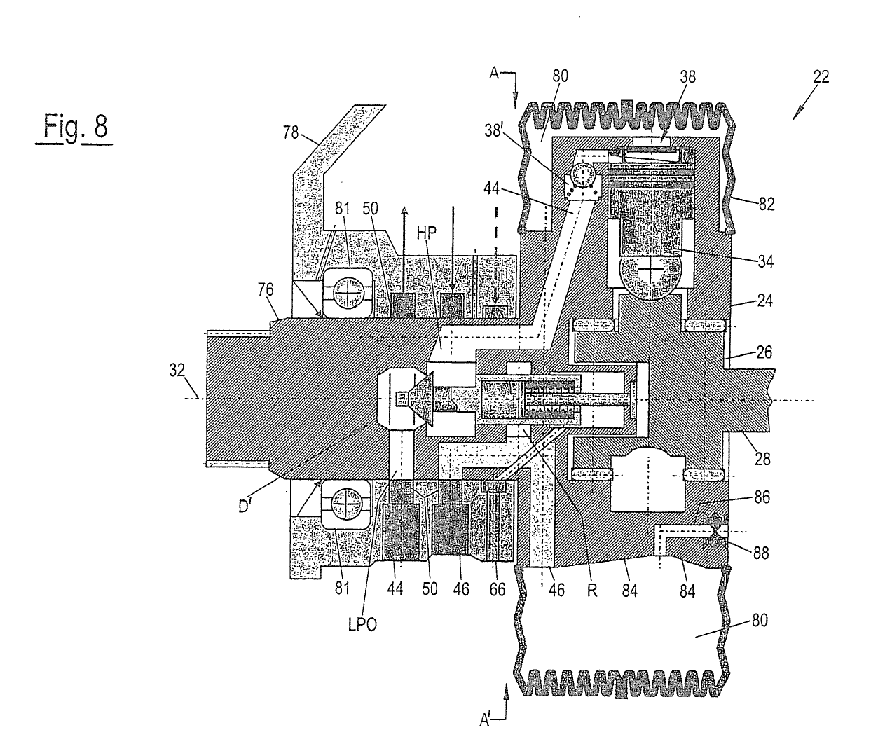

FIG. 8 perpendicular to the plane of the drawing of FIG. 8; and

FIG. 10 illustrates a schematic representation of a further embodiment of the powertrain in accordance with the invention.

### DETAILED DESCRIPTION

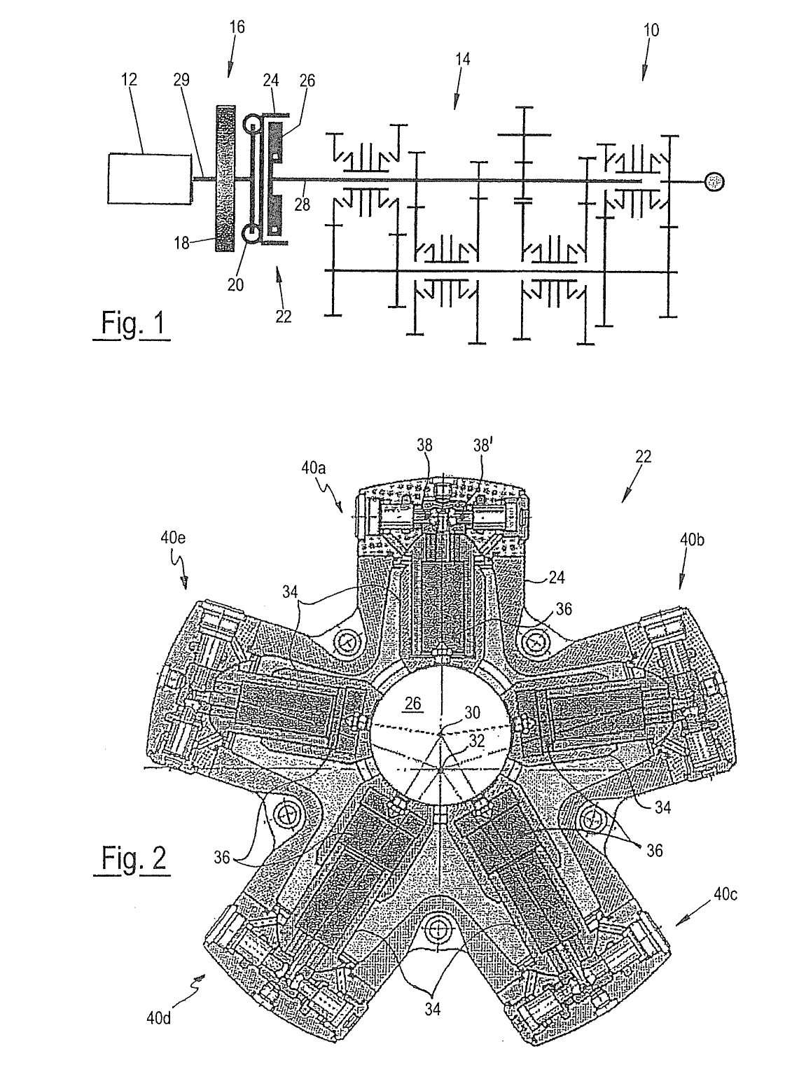

FIG. 1 shows an embodiment of a powertrain 10 of a vehicle in accordance with the invention having an engine or motor 12 (e.g. an internal combustion engine or an electric motor), a main transmission 14, a torque transfer device 16 serving as a main clutch and a flywheel 18. The torque transfer device 16 in the embodiment shown forms a constructional unit comprising a torsion damper 20 and a hydrostatic pump 22, with the torsion damper 20 being directly connected to a pump housing 24 of the pump 22. A torque transfer device 16 can generally also be provided without an integrated torsion damper 20 so that the torque transfer device 16 substantially comprises a pump 22 and a pressure control device (not shown in FIG. 1) associated therewith.

The torsion damper 20 is in turn coupled via a flywheel 18 to the engine or motor 12. A rotor 26 of the pump 22 is rotationally fixedly coupled to an input shaft 28 of the main transmission 14. The main transmission 14 will not be described in more detail in the following since its embodiment is generally known and is not of any further relevance for the function of the torque transfer device 16 in accordance with the invention. The main transmission 14 can, for example, be a manual or automated manual transmission or an automatic transmission.

The pump housing 24 forms the first pump part and the rotor 26 forms the second pump part, both pumps parts being rotatable relative to one another.

The assembly of the flywheel 18 at the engine/motor side and of the torque transfer device 16 satisfies a plurality of functions. On the one hand, the rotational irregularities introduced into the power train 10 by the engine or motor 12 can thereby be reduced since the above-named assembly has the effect of a dual mass flywheel. The flywheel at the transmission side is in this respect formed by the pump housing 24 which is connected to the flywheel 18 at the engine/motor side via the torsion damper 20. In addition, the hydrostatic pump can be utilized as a start-up and shift clutch —n a manual or automated manual transmission—or as a torque converter—in an automatic transmission.

As initially stated, the situation is present on a starting up of the vehicle that an engine/motor output shaft 29 is driven to make a rotation at a specific speed by the engine/motor 12 while the vehicle is stationary and the transmission input shaft 28 is thus idle. A drive-effective connection of the engine or motor 12 to the main transmission 14 therefore requires a gradual transfer of the drive torque of the engine or motor 12 to the transmission input shaft 28 until the condition of a uniformity of rotational speed is achieved. How this can be effected by means of the hydrostatic pump 22 will be described in detail in the following with reference to the drawings.

Radial piston pumps represent a pump type particularly suitable for use in a torque transfer device 16. The function of a radial piston pump 22 will be explained with reference to FIG. 2 which shows a section through a radial piston pump 22. The radial piston pump 22 shown can generally also be operated as an engine—in addition to its pump function—that is it can produce a rotary movement by controlled application of pressure. Since, however, in the present application, only the pump function—that is the conveying of a hydraulic fluid on a rotational speed difference between the pump housing 24 and the rotor 26—is of importance, only the aspects of the radial piston pump 22 required for the understanding of the torque transfer device 16 are considered. In other words, a simplified version of the radial piston pump 22 shown by way of example can be used in a torque transfer device 16 and this is also preferred due to the simple construction.

The radial piston pump 22 shown includes the rotor 26 which has a circular outline in the region of the pump 22, with the center 30 of the circular shape being offset with respect to the common axis of rotation 32 of the pump housing 24 and of the rotor 26 or of the associated input shaft 28 of the main transmission 14. In other words, the rotor 26 is an eccentric element. The rotor 26 is in drive communication with five pistons 34 which each have a piston space 36. On a rotation of the rotor 26 relative to the housing 24, the volumes of the piston spaces 36 are alternately increased and decreased in size., In other words, a hydraulic fluid which first flows through a valve 38 is subsequently expelled again through a further valve 38′ of the respective piston 34 by the rotary movement of the rotor 26 relative to the housing 24. A hydraulic fluid is thus conveyed from a suction space (not shown) in communication with the valve 38 to a pressure space (not shown) which is in communication with the valve 38′. The valves 38, 38′ can be simple check valves in the form of passive seated valves in a simple pump 22—that is without any hydraulic engine/motor function.

In the condition shown in FIG. 2, initially hydraulic fluid is sucked into the piston space 36 of a cylinder 40a of the radial piston pump 22 on a counter clockwise rotation of the rotor 26 since the piston space 36 initially has a minimal volume. The pistons 34 of the cylinders 40b and 40c are also in the suction phase. If a maximum volume of the respective piston space 36 has been reached, the volume of the piston space 36 is now reduced again, that is the fluid pressure is increased, due to the effect of the rotation of the rotor 26. On an increase in the pressure the valve 38 acting as a check valve automatically closes. The volume of the piston space 36 is further reduced by the further rotation of the rotor 26 and the hydraulic fluid continues to be pressurized until, from a specific threshold value onward, the valve 38′—for example a ball valve loaded by spring force—opens and the hydraulic fluid is discharged into the pressure space, not shown. It can easily be seen from the described manner of operation of the radial piston pump 22 that the quantity of hydraulic fluid conveyed per unit of time only depends on a rotational speed difference between the pump housing 24 and the rotor 26. In other words, no hydraulic fluid is conveyed when the housing 24 and the rotor 26 rotate at the same speed.

In the application of the radial piston pump 22 described here, however, it is not the conveying of a hydraulic fluid which is of central importance, but rather a controlled hydrostatic coupling of the housing 24 to the rotor 26 to be able to transfer torque from the engine or motor 12 to the main transmission 14. This can be realized, on a reversal of the above-described principle of operation of the radial piston pump 22, in that the conveying of the hydraulic fluid is deliberately prevented. If the pump 22 can namely not discharge any hydraulic fluid through the valve 38′, the rotor 26 can no longer rotate with respect to the housing 24. The coupling is cancelled in that the hydraulic fluid conveying is again permitted.

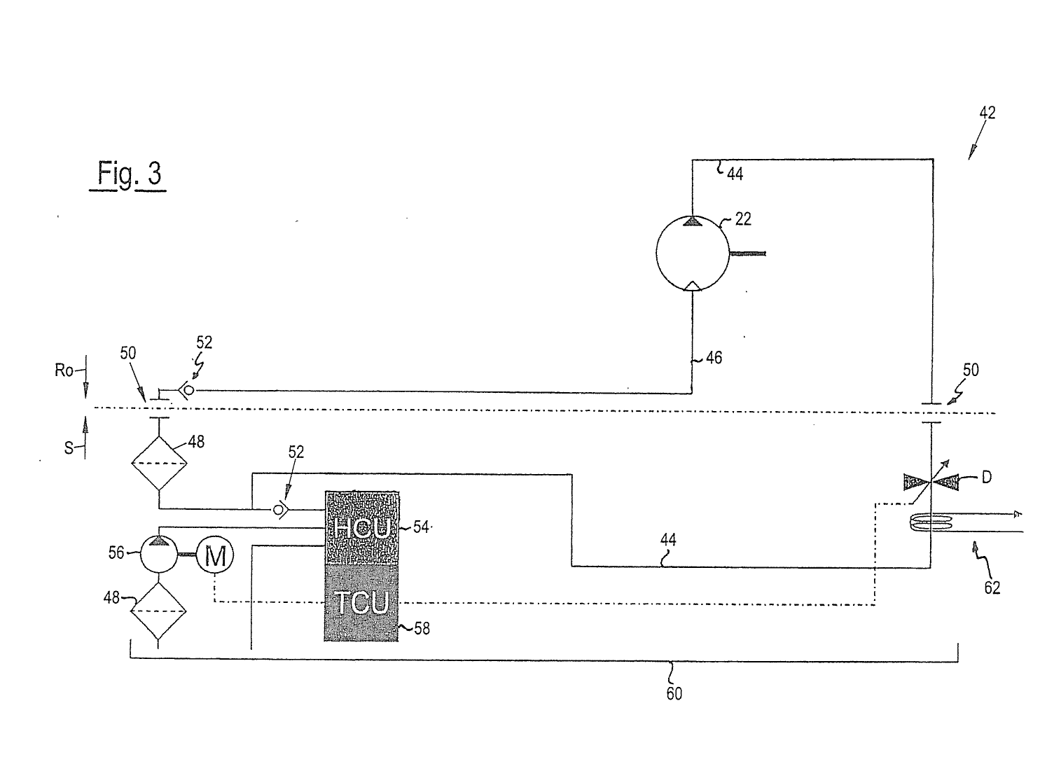

The torque transfer by the torque transfer device 16 is thus based substantially on a pressure control of the hydraulic fluid conveyed by the pump 22 or on the control of the pump pressure present at the pressure space side. A schematic view of an embodiment of a pressure control 42 is shown in FIG. 3.

The pump 22 is connected to a pressure line 44 and to a suction line 46. The pressure line 44 is in communication with the suction line 46 via a hydraulic fluid filter 48, a rotary leadthrough 50 and a check valve 52. The rotary leadthrough 50 is required since the pump 22, the suction line 46 and parts of the pressure line 44 rotate (rotating region Ro above the dashed line), while the remaining components of the control 42 still to be described in part in the following are arranged in stationary form (stationary region S beneath the dashed line).

The pressure control 42 moreover has a hydraulic control unit (HCU) 54 which is in communication with the pressure line 44. The hydraulic control unit 54 is supplied with pressurized hydraulic fluid by a pump 56 in communication with a motor M, with the motor M being electrically controlled by a transmission control unit (TCU) 58. The pump 56 takes the hydraulic fluid from a sump 60.

To be able to control the hydraulic fluid quantity conveyed by the pump 22, the pressure line 44 of the pump 22 has a restrictor valve D which is electrically controllable by the transmission control unit 58. A hydraulic control of the restrictor valve D by the hydraulic control unit 54 is generally also possible or, for example, an electromechanical control. A heat exchanger 62 which serves for the reduction of the temperature of the hydraulic fluid is arranged after the restrictor valve D of the pressure line 44 in the flow direction of the hydraulic fluid. The restrictor valve D is arranged in the stationary region S so that a rotary leadthrough 50 is also provided in the extent of the pressure line 44 upstream relative to the restrictor valve D.

The embodiment of the pressure control 42 shown is characterized by its simple conceptualization. The control of the torque transfer device 16 takes place via the control of the restrictor valve D. When the vehicle is stationary, the restrictor valve D is opened so that hydraulic fluid is conveyed substantially without restriction through the opened restrictor valve D due to the rotational speed difference between the pump housing 24 driven by the engine/motor 12 and the rotor 26 rotationally fixedly connected to the input shaft 28 of the main transmission 14. Any losses of hydraulic fluid—for example by leak at the rotary leadthroughs 50—are balanced by the supply of hydraulic fluid by the hydraulic control unit 54. In this condition, the engine/motor 12 and the main transmission 14 are substantially decoupled, with only small drag torques and power losses occurring due to the circulation of the hydraulic fluid in the hydraulic circuit. The heat occurring due to the pump power can be discharged efficiently via the heat exchanger 62.

To introduce a torque transfer from the rotating pump housing 24 to the still idling rotor 26, the restrictor valve D is gradually closed. The pressure in the pressure line 44 of the pump 22 is increased by the restriction by means of the restrictor valve D, whereby increasingly more torque is transferred from the pump housing 24 to the rotor 26. The speed of rotation of the rotor 26 gradually also matches the speed of rotation of the pump housing 24 driven by the engine/motor 12 due to the increasing transfer of torque. This procedure continues for so long until the restrictor valve D is completely closed. The rotor 26 is blocked mechanically with respect to the pump housing 24 by the blocking of the restrictor valve D so that—apart from fluid losses due to unavoidable leaks—both rotate substantially at the same speed of rotation. In this condition, a substantially loss-free transfer of torque from the pump housing 24 to the rotor 26 takes place.

A decoupling of the engine/motor 12 from the main transmission 14 takes place in an analog fashion on a reversal of the above-described procedure.

It becomes clear from the above description that the torque transfer device 16 based on a hydrostatic pump 22 can replace a friction clutch as the start-up element in a manual or automated manual transmission, with a separate device for the cooling being able to be dispensed with since the cooling of the start-up element—that is of the pump 22—takes place by the actuating fluid itself and is therefore very efficient so that a separate coolant pump is not necessary. The advantage results, among others, with respect to a conventional torque converter that the present torque transfer device 16 does not have any fixed torque transfer characteristic, but can rather be controlled individually in accordance with the demands. In addition, the necessity of providing a torque converter bridging clutch is dispensed with since the torque transfer is substantially loss-free in the blocked condition.

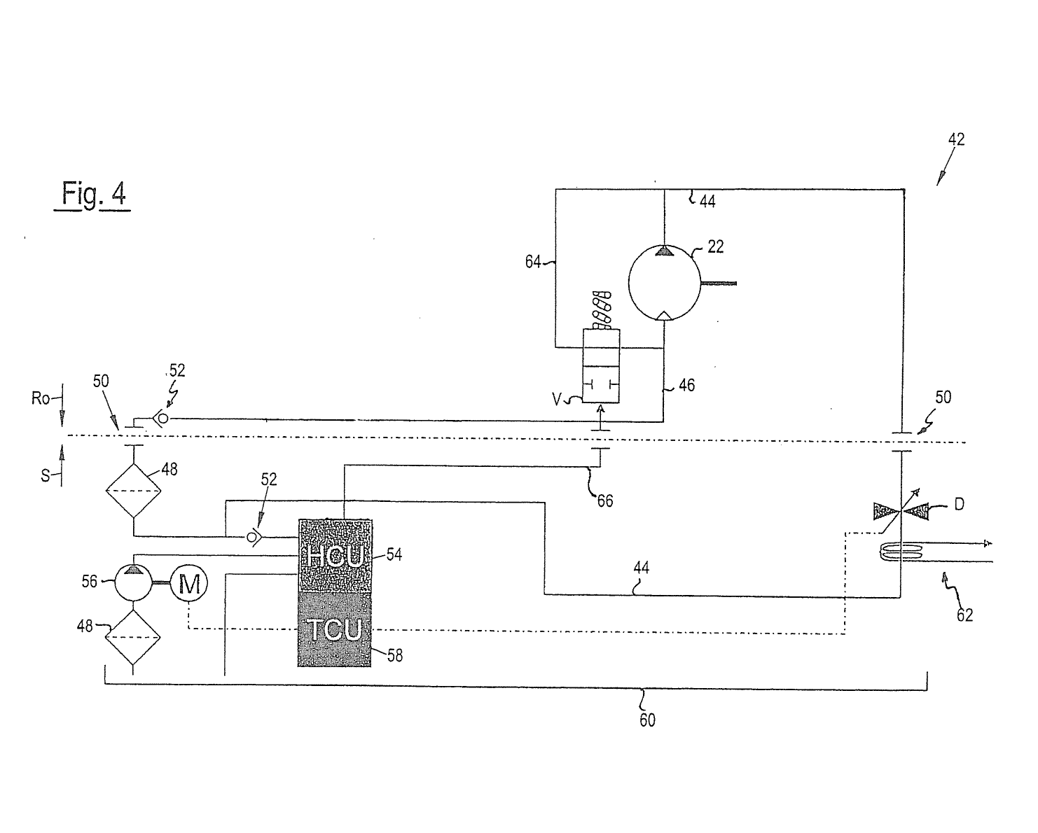

FIG. 4 shows a further embodiment of the pressure control 42. This embodiment additionally has a short-circuit line 64 which directly connects the pressure space of the pump 22 to the suction space, with the idling circulation of the hydraulic fluid in the decoupled condition of the torque transfer device 16 being able to be designed with even lower loss by said short-circuit line. The short-circuit line 64 can be opened and closed by a control valve V depending on requirements. The control valve V is actuated by a hydraulic control line 66 from the hydraulic control unit 54. An electrical or electromechanical control of the valve V is likewise possible. The control valve V can be a simple ON/OFF valve.

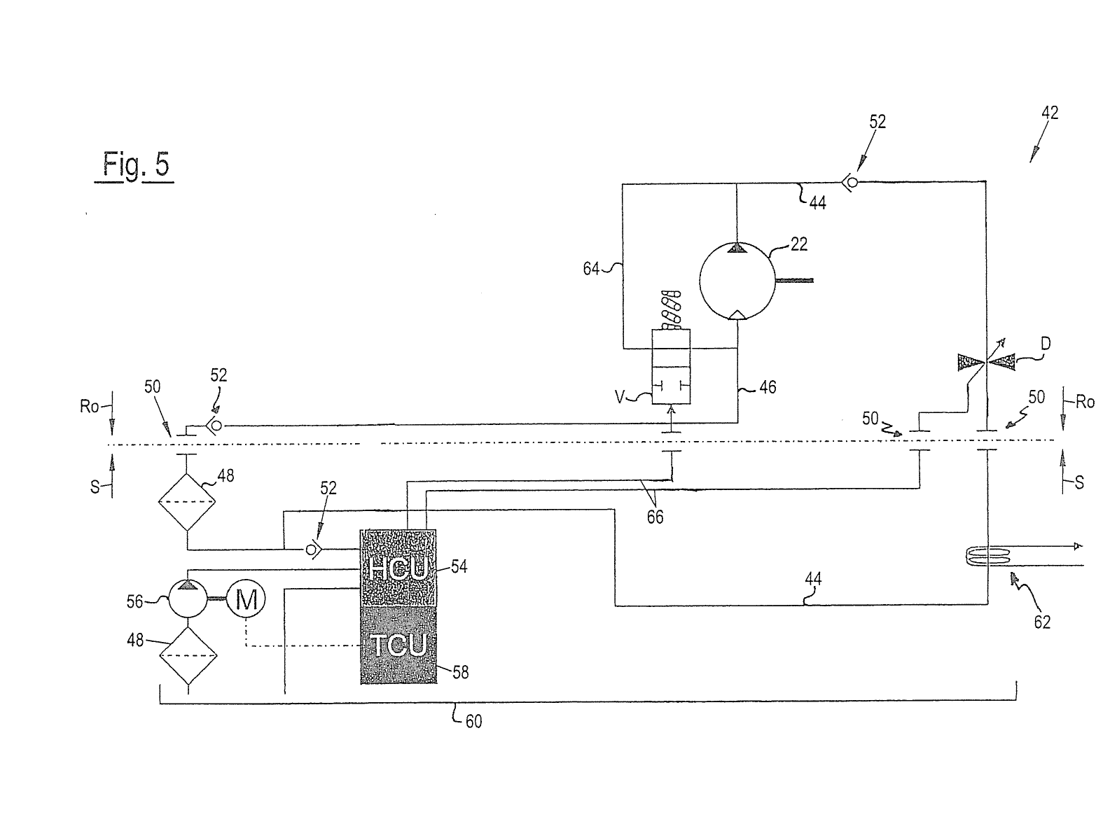

FIG. 5 shows a further variant of the pressure control 42. The restrictor valve D in this embodiment is arranged in the rotating region Ro of the control 42 and is hydraulically controlled by the hydraulic control unit 54. The leak losses at the rotary leadthrough 50 due to the lower hydraulic pressure after the restrictor valve D in the flow direction are minimized by the arrangement of the restrictor valve D in the rotating region Ro. In addition, a particularly compact and robust construction is made possible.

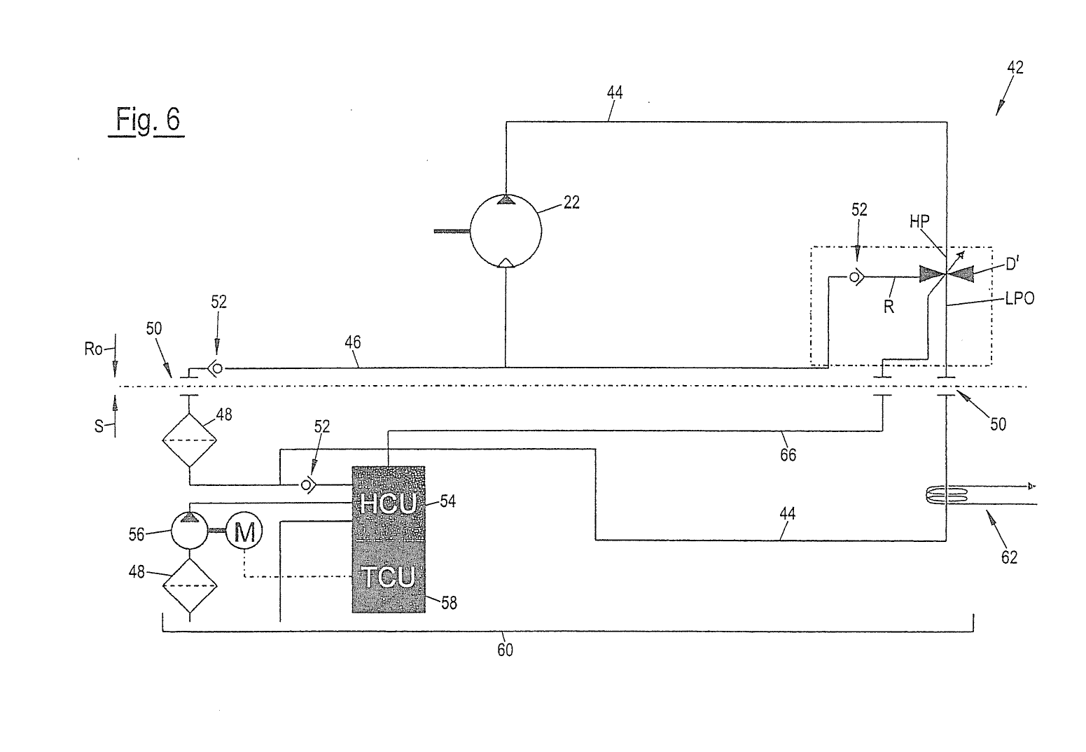

FIG. 6 shows a further variant of the pressure control 42 which, unlike the variants of FIGS. 4 and 5, has no short-circuit line 64 with a control valve V. An input HP of the restrictor valve D′ is connected to the pressure line 44 of the pump 22. A first output R of the restrictor valve D′ is in communication directly with the suction line 46 and thus with the suction space of the pump 22 via the check valve 52 within the rotating region Ro. The corresponding connection line in particular extends along or within the rotating first pump part 24. A second output LPO of the restrictor valve D′ is in communication indirectly with the suction line 46 of the pump 22 via the heat exchanger 62. The corresponding connection line in particular extends within the stationary region S, i.e. along or within a stationary housing of the torque transfer device. Hydraulic control signals are supplied to the restrictor valve D′ via the control line 66.

The restrictor valve D′ in this embodiment thus additionally takes over the functions of the control valve V in addition to its restrictor function, which brings along a simplified construction and control of the pressure control 42.

An electromechanical control of the restrictor valve D or D′ is also possible in the embodiments in accordance with FIGS. 5 and 6.

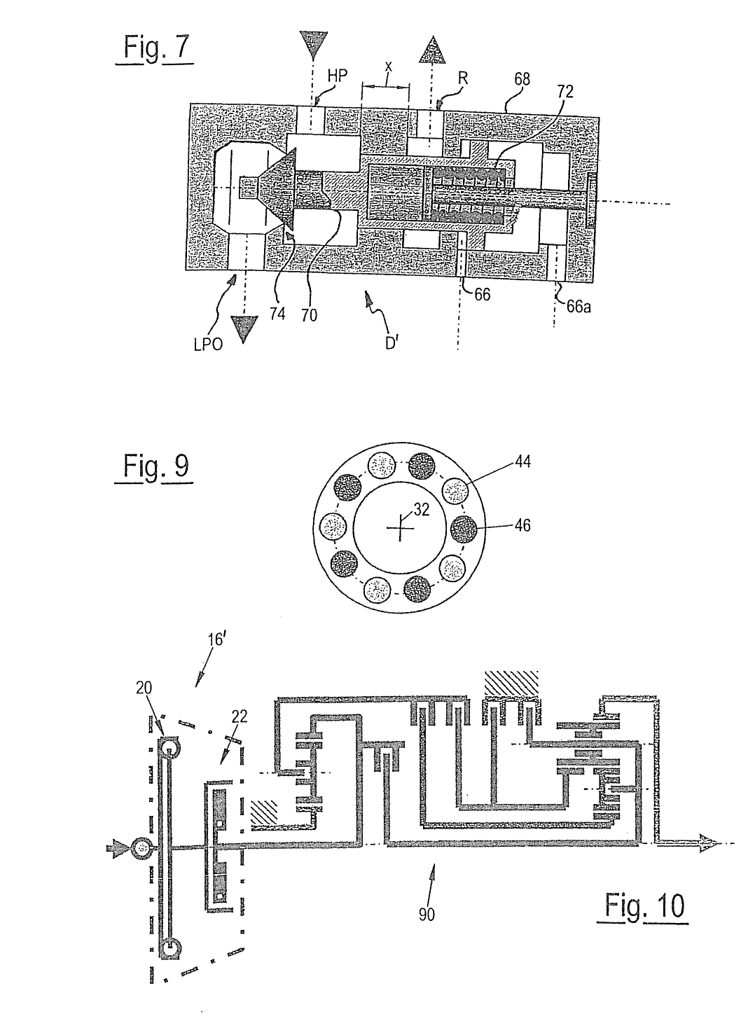

An embodiment of the restrictor valve D′—highlighted by a dashed box together with the check valve in FIG. 6—will be described in the following with reference to FIG. 7.

FIG. 7 shows a cross-section through a restrictor valve D′. The triangles associated with the input HP and the outputs R and LPO of the restrictor valve D′ symbolize the flow direction of the hydraulic fluid through the corresponding openings.

The restrictor valve D′ has a valve housing 68 and a valve gate 70 arranged therein. The restrictor valve D′ shown in FIG. 7 is in a completely closed condition. In a closed condition, that is when the valve gate 70 is displaced to the right with respect to the position shown, the restrictor valve D′ receives hydraulic fluid conveyed by the pump 22 through the input HP, said hydraulic fluid leaving the restrictor valve D′ again through the output LPO. If the valve gate 70 is displaced to the right by more than an offset X, a large part of the hydraulic fluid is sucked out via the output R and is supplied to the suction space of the pump 22. In this case, the restrictor valve D′ short-circuits the pump 22 and takes over the function of the short-circuit line 64 of the above.-discussed embodiments. The large part of the hydraulic fluid therefore remains in the rotating region Ro, whereby the power losses caused by the pressure control 42 are minimized.

As already addressed above, the restrictor valve D′ is completely closed in the representation in accordance with FIG. 7. The flow of fluid from the input HP to the outputs LPO and/or R is blocked by the valve gate 70. This results in a blocking of the pump 22 which thus transfers torque from the housing 24 to the rotor 26.

The position of the valve gate 70 can be changed by varying a control pressure in the control lines 66 and 66a acting against the spring force exerted by a spring 72. Starting from an opened state of the restrictor valve D′, the closing of the restrictor valve D′ and the effects of this procedure will be described in the following.

On actuation of the restrictor valve D′, the valve gate 70 moves out of the opened state to the left. The output R is initially closed hereby. The fluid conveyed by the pump 22 thus escapes via the output LPO and leaves the rotating region Ro. Based on the extended flow path of the hydraulic fluid, drag torques are now generated which are, however, initially hardly noticeable. Finally, the valve gate 70 approaches a control edge 74. This means that an increasing pressure is built up at the pump 22 and an increasing portion of the torque of the engine/motor 12 is accordingly transferred via the pump 22. The heat generated by the amplified power of the pump 22 is led off by the conveyed hydraulic fluid via the output LPO and is removed from the fluid again in the stationary region S by the heat exchanger 62.

FIG. 8 shows a cross-section through a part of a constructional implementation of an embodiment of the torque transfer device 16. The pump 22 can be seen at the right in the Figure and includes the rotating pump housing 24 and the rotor 26. The rotor 26 is connected to the input shaft 28 of the main transmission 14.

As can be seen from FIG. 8, the rotor 26 is characterized by a compact construction, in particular in the radial direction. Its moment of inertia with respect to the axis of rotation 32 is thereby very small. The small moment of inertia of the rotor 26 reduces the inertia of the part of the main transmission 14 at the input side, whereby gear changes in the main transmission 14 can be carried out faster and easier. In addition, any synchronization devices present in the main transmission 14 can be designed to be less complex and/or expensive, which represents an additional saving potential.

A prolongation 76 of the pump housing 24 projecting to the left receives the restrictor valve D′ and sections of the pressure line 44 and suction line 46 associated with the pump 22. In other words, the restrictor valve D′ is integrated into the rotating pump housing 24.

The output LPO of the restrictor valve D′ is connected to the pressure line 44 and the output R is connected to the suction line 46 in the stationary region S in each case by rotary leadthroughs 50 in a stationary housing. A rotary leadthrough 50 is also provided for the control line 66. The suction line 46 of the pump 22 connected to the output R is in communication with a suction space 80.

The integrated and compact arrangement of the pump 22 and of the restrictor valve D′ controlling it enables short flow passages—which thus minimize drag torques—for the circulation of the fluid in the idling state of the pump 22. The construction is also robust and simple.

The flow path of the hydraulic fluid will be described in the following, with the presence of a rotational speed difference between the input shaft 28 of the main transmission 14, on the one hand, and the pump housing 24 rotatably journalled in bearings 81—and thus to the engine/motor 12 connected thereto—on the other hand, being required. The restrictor valve D′ would have to be opened for this purpose—counter to the representation in FIG. 8.

When the rotor 26 is moved out of the position shown in FIG. 8, hydraulic fluid is sucked through the valve 38 from the suction space 80 into the piston space of the piston 34. On a continued rotation of the rotor 26, the hydraulic fluid now located in the piston space is pressurized until the fluid pressure exceeds the spring force of a spring in the valve 38′, whereby the valve 38′ is opened and hydraulic fluid can flow through the pressure line 44 to the input HP of the restrictor valve D′. As described above, a large portion of the fluid is again supplied to the suction space 80 via the output R and the suction line 46 with a valve gate 70 displaced correspondingly far to the right. Some of the fluid can also escape through the output LPO with an opened restrictor valve D′ and can be supplied to a heat exchanger 62 via the pressure line 44. The led off hydraulic fluid can be fed back into the rotating region Ro through the line 46 and a rotary leadthrough 50.

The suction space 80 common to all cylinders 40a-40e of the pump 22 is made as an annular space which surrounds the pump 22 in the peripheral direction and is filled with the hydraulic fluid along its periphery. The suction space 80 is bounded by the pump housing 24, on the one hand, and by a ring hood 82, on the other hand. The ring hood 82 is an at least sectionally elastic envelope, in particular made of metal, for example a metal bellows. Two correspondingly shaped steel sheets are flanged and welded together, for example along a center connection site extending in the peripheral direction. Alternatively, for example, a one-part ring hood can be provided which has at least one elastic side wall (that is an elastic ring wall extending in the radial direction) and a substantially inelastic cover surface (that is a substantially inelastic ring wall extending in the axial direction). The reception capacity of the suction space 80 is hereby independent of the speed of rotation since no enlargement, or only a slight enlargement, of the suction space takes place on the basis of centrifugal forces.

The use of the ring hood 82 provides a number of advantages. The suction space 80 in particular acts as a pressure store due to the elastic properties of the ring hood 82, whereby, for example, cavitation in the fluid is prevented which can otherwise arise on large pressure changes in the suction space 80, for instance on a sudden operation of the pump 22 when a large rotational speed difference is present between the rotor 26 and the housing 24, such as on the starting up. Cavitation can among other things result in damage to the components and to the hydraulic fluid and must therefore be avoided as much as possible.

Since the hydraulic fluid peripherally surrounds the pump 22 and thus forms a peripherally closed oil jacket, the ring hood 82 furthermore improves the cooling of the fluid and it reduces the noise development as well as aerodynamic losses, with these advantages also being achieved without the explained elastic design of the ring hood 82.

Any gas bubbles present in the fluid in the interior of the suction space 80 are urged radially inwardly by the centrifugal force and collect at the inlet of a venting passage 86 due to two roof-like inclines 84 so that the gas can escape via a venting valve 88.

Deviating from the embodiment shown in FIG. 8, the restrictor valve D′ can be arranged rotated by 90° with respect to the axis of rotation 32 so that the centrifugal force supports an opening movement of the restrictor valve D′.

FIG. 9 shows a section through the housing prolongation 76 along the line AA′, with details of the restrictor valve D′ not being shown. FIG. 9 schematically illustrates an exemplary arrangement of the pressure lines 44 and suction lines 46 in the prolongation 76. It can be seen from FIG. 9 that the pump 22 has five pistons in the example shown, since five pressure lines 44 and five suction lines 46 are present. The pump 22 can, however, also have different numbers of pistons.

FIG. 10 shows a further torque transfer device 16′ which includes a pump 22 and a torsion damper 20, with them not being directly connected to one another in deviation from the torque transfer device 16. In FIG. 10, the torque transfer device 16′ is connected to an automatic transmission 90 and thus here replaces a hydrodynamic torque converter.

It must be pointed out that the torque transfer device in accordance with the invention cannot only be used as replacement for a main clutch in the powertrain of a vehicle, but is rather suited for a plurality of applications in which a reliable and robust torque transfer is of importance, in particular also at a different position in a powertrain. For example, such a torque transfer device can be used in a transfer case of a motor vehicle with all-wheel drive which can be switched in or in a lock or a overriding drive for a differential gear.

### REFERENCE NUMERAL LIST

10 powertrain

12 engine/motor

14 main transmission

16, 16′ torque transfer device

18 flywheel

20 torsion damper

22 hydrostatic pump

24 pump housing

26 rotor

28 transmission input shaft

29 engine/motor output shaft

30 center

32 axis of rotation

34 piston

36 piston space

38, 38′ valve

40a-e cylinder

42 pressure control

44 pressure line

46 suction line

48 hydraulic fluid filter

50 rotary leadthrough

52 check valve

54 hydraulic control unit

56 pump

58 transmission control unit

60 sump

62 heat exchanger

64 short-circuit line

66, 66a control line

68 valve housing

70 valve gate

72 spring

74 control edge

76 housing prolongation

78 stationary housing

80 suction space

81 bearing

82 ring hood

84 incline

86 venting passage

88 venting valve

90 automatic transmission

D, D′ restrictor valve

M motor

V control valve

HP restrictor valve input

LPO, R restrictor valve output

X offset

1. A torque transfer device for a powertrain of a motor vehicle, having a pump which has a first pump part, a second pump part, a suction space and a pressure space, wherein the first pump part and the second pump part are rotatable relative to one another, wherein a hydraulic fluid can be conveyed from the suction space into the pressure space of the pump by a rotary movement of the first pump part relative to the second pump part, wherein a torque can be transferred between the first pump part and the second pump part via the hydraulic fluid, said torque depending on the pump pressure generated by the pump, wherein at least one pressure control device is associated with the pump, with a fluid flow conveyed by the pump being variably restrictable by means of said pressure control device to vary the speed of rotation of the first pump part and of the second pump part relative to one another.

2. A torque transfer device in accordance with claim 1, wherein the first pump part and the second pump part are arranged rotatably.

3. A torque transfer device in accordance with claim 1, wherein the pump can be hydraulically blocked by means of the pressure control device to connect the second pump part substantially rotationally fixedly to the first pump part of the pump.

4. A torque transfer device in accordance with claim 1, wherein the pump can be hydraulically short-circuited by means of the pressure control device to decouple the second pump part from the first pump part of the pump.

5. A torque transfer device in accordance with claim 4, wherein a short-circuit line of the pump connecting the pressure space and the suction space extends along the first pump part.

6. A torque transfer device in accordance with claim 5, wherein the pressure control device has a control valve by which the short-circuit line can be selectively opened or blocked.

7. A torque transfer device in accordance with claim 1, wherein the pressure control device includes at least one controllable restrictor valve by means of which the fluid flow conveyed by the pump can be restricted.

8. A torque transfer device in accordance with claim 7, wherein the pressure space of the pump can be coupled directly to a suction line of the pump via the restrictor valve.

9. A torque transfer device in accordance with claim 8, wherein the pressure space of the pump, the restrictor valve and the suction line of the pump are formed at the same pump part, with the direct coupling of the pressure space to the suction line taking place within or along this pump part.

10. A torque transfer device in accordance with claim 7, wherein the restrictor valve is arranged at the first pump part.

11. A torque transfer device in accordance with claim 10, wherein the restrictor valve has an actuation direction which extends perpendicular to an axis of rotation of the first pump part, with the restrictor valve being designed such that a centrifugal force active on a rotation of the first pump part supports an opening of the restrictor valve.

12. A torque transfer device in accordance with claim 7, wherein a cooling device for the cooling of the hydraulic fluid restricted by means of the restrictor valve is arranged along a connection path of the pressure space of the pump of the pump, with the cooling device being arranged at a stationary housing of the torque transfer device.

13. A torque transfer device in accordance with claim 7, wherein the restrictor valve has an input opening, a first output opening and a second output opening, with the input opening being in communication with the pressure space of the pump, with the first output opening being in communication directly with the suction space of the pump via a first connection line which extends along the first pump part, and with the second output opening being in communication with the suction space of the pump via a second connection line which extends along a cooling device.

14. A torque transfer device in accordance with claim 13, wherein the restrictor valve is designed such that the portions of the hydraulic fluid which respectively flow out through the output openings can be controlled by the restrictor valve, said hydraulic fluid flowing into the restrictor valve.

15. A torque transfer device in accordance with claim 13, wherein the cooling device is arranged at a stationary housing of the torque transfer device.

16. A torque transfer device in accordance with claim 1, wherein the pressure control device can be controlled such that a variably determinable portion of a torque can be transferred between the first pump part and the second pump part.

17. A torque transfer device in accordance with claim 1, wherein at least one of the pump parts is peripherally surrounded by an annular space which is filled with the hydraulic fluid.

18. A torque transfer device in accordance with claim 1, wherein the suction space has an annular space which is bounded at least partly by an elastic ring wall which enables a volume change of the suction space in dependence on the fluid pressure in the suction space.

19. A torque transfer device in accordance with claim 18, wherein the ring wall is part of a ring hood or is formed by a ring hood which is made of metal.

20. A torque transfer device in accordance with claim 1, wherein the first pump part of the pump forms an input of the torque transfer device and the second pump part forms an output of the torque transfer device.

21. A torque transfer device in accordance with claim 1, wherein the pump is a radial piston pump.

22. A torque transfer device in accordance with claim 1, wherein a control unit is provided by means of which the pressure control device can be controlled such that the pressure control device is completely closed for the hydraulic blocking of the pump for a substantially complete transfer of a torque between the first pump part and the second pump part of the pump; and in that the pressure control device is completely opened for the hydraulic short-circuiting of the pump for a mutual decoupling of the first pump part and of the second pump part.

23. A torque transfer device in accordance with claim 22, wherein the pressure control device can be controlled such that a throughflow rate of the hydraulic fluid through the pressure control device is reduced to increase the torque transferred between the first pump part and the second pump part and such that the throughflow rate of the hydraulic fluid through the pressure control device is increased to reduce the torque transferred between the first pump part and the second pump part.

24. A torque transfer device in accordance with claim 1, wherein the first pump part is connected to a flywheel via a rotational vibration damper.

25. A torque transfer device in accordance with claim 1, wherein the first pump part is connected to an output element of a drive unit of the motor vehicle and the second pump part is connected to an input shaft of a main transmission.

26. A torque transfer device in accordance with claim 1, wherein the first pump part is a pump housing of the pump.

27. A powertrain of a motor vehicle having a drive unit, a main transmission and a torque transfer device, wherein the torque transfer device is arranged between the drive unit and the main transmission and having a first pump part, a second pump part, a suction space and a pressure space, wherein the first pump part and the second pump part are rotatable relative to one another, wherein a hydraulic fluid can be conveyed from the suction space into the pressure space of the pump by a rotary movement of the first pump part relative to the second pump part, wherein a torque can be transferred between the first pump part and the second pump part via the hydraulic fluid, said torque depending on the pump pressure generated by the pump, wherein at least one pressure control device is associated with the pump, with a fluid flow conveyed by the pump being variably restrictable by means of said pressure control device to vary the speed of rotation of the first pump part and of the second pump part relative to one another.
